(19) United States
(12) Patent Application Publication
(10) Pub. No.: US 2018/0346122 A1
(43) Pub. Date: Dec. 6, 2018

(54) IN-FLIGHT SERVICE CART AND THERMALLY INSULATED CONTAINER FOR AN IN-FLIGHT SERVICE CART

(71) Applicants: Tower Cold Chain Solutions Limited, Reading (GB); DHL Supply Chain Limited, Milton Keynes (GB)

(72) Inventors: Christopher KZRAK, Pangbourne (GB); James VANN, Hampton Hill (GB); Chirag TRIVEDI, Camberley (GB); Robert SIMPSON, Cuffley (GB); Martin WILLMOR, Cheshunt (GB)

(21) Appl. No.: 15/771,708

(22) PCT Filed: Oct. 27, 2016
(86) PCT No.: PCT/GB2016/053334

§ 371 Date: Apr. 27, 2018

(30) Foreign Application Priority Data
Oct. 30, 2015 (GB) 1519257.8

(51) Int. Cl. B64D 11/00; B62B 3/00; B62B 3/02

(52) U.S. Cl. CPC B64D 11/0007; B62B 3/005; B62B 2204/04; B62B 3/02; B62B 2204/06; B62B 3/004

(57) ABSTRACT

An in-flight service cart (1) for use on an aircraft for maintaining a payload such as foodstuffs and the like within a selected temperature range, said in-flight service cart (1) including: a housing (3) having a storage volume; and at least one thermally insulated container (5) removably mounted within the housing (3), said container having an outer casing (7), a thermally conductive inner casing (11), thermal insulation (9) located between the outer casing (7) and the inner casing (11), said thermal insulation including at least one vacuum insulation panel (9a-e), a payload volume for storing foodstuffs, an opening (29,47) providing access to the payload volume, a closure member (13) for closing the opening (29,47), at least one thermal energy storage unit (15) located within the inner casing (11), said thermal energy storage unit(s) (15) including a phase change material that is arranged to change phase at a temperature greater than or equal to −10° C.; wherein the inner casing (11) and closure member (13) define the payload volume for storing the foodstuffs, and the thermal energy storage unit(s) (15) is positioned in thermal contact with the inner casing (11), the arrangement being such that the inner casing (11) provides a thermally conductive pathway for conducting heat entering the container (5) to the thermal energy storage unit (15). A thermally insulated container (5) for an in-flight service cart (1) is also provided.

The present invention relates to an in-flight service cart and a thermally insulated container for an in-flight service cart.

When storing foodstuffs on an aircraft it is desirable to maintain the temperature of foodstuffs, such as food and beverages, in the range +2° C. to +8° C. If the temperature of the foodstuffs becomes too high, there is an increased risk of bacteria forming in the food and the food will spoil more quickly. If the foodstuffs drop below +2° C. there is a possibility that the foodstuffs will freeze. While freezing the foodstuffs is not dangerous for the consumer, it is recognised that the freezing and defrosting foodstuffs can detract from the presentation of the foodstuffs, and in some cases the taste. Furthermore, if the foodstuffs are frozen, there can be a delay in serving the foodstuffs, while waiting for them to defrost.

It is known in the art to use dry ice (carbon dioxide ice) in order to chill the foods within the in-flight service carts. While this ensures that the products do not exceed the +8° C. range, there is a tendency for many foodstuffs to freeze. Also, with this technology it is difficult to control the temperature distribution within the cart, which can lead to cold spots occurring, and the dry ice can run out relatively quickly.

Consequently, there is the desire for a refrigeration type unit for an aircraft that provides more even temperature distribution within the container, thereby reducing the possibility of cold spots occurring and reducing the possibility of foodstuffs stored therein from freezing. There is also a desire to increase the period of time for which foodstuffs are chilled, for example for use on long-haul flights.

Another problem on aircraft is that in-flight service carts, and any containers stored therein, may experience sudden loading, for example due to the aircraft flying through turbulent air. This can cause unsecured doors and hatches to swing violently, risking injury to cabin crew and passengers. Accordingly, it is usual for cart and container doors to be closed, and secured in place during a flight. At the same time, the cabin crew has to frequently access the in-flight service carts, and any containers stored therein, for example when serving food. Therefore it is desirable to have in-flight service carts and containers that can be quickly and easily opened when access is required. Thus a balance has to be struck between, on the one hand providing secure locks on doors, and on the other hand, providing fast easy access to goods stored in the service carts and containers.

A further problem for in-flight service carts is that space is very limited within the aircraft cabin and therefore it is desirable to provide compact units, with few protruding parts. In some circumstances, it is also desirable to produce a new in-flight service cart that meets current standards so that the cart is compatible for use on existing aircraft and with existing aircraft equipment. This often constrains the service cart dimensions, for example to fit within existing designated spaces, and to receive and store existing food trays. These dimensional constraints can be challenging, since the new cart is often required to provide improved thermodynamic performance, for example is required to maintain the temperature within the cart in a predetermined range for a longer period of time than previous designs. This can be difficult to achieve.

It is an object of the present invention to provide an in-flight service cart and a thermally insulated container for the in-flight service cart that mitigates at least one of the aforementioned disadvantages, or at least provides an alternative configuration to known apparatus.

According to one aspect of the invention there is provided an in-flight service cart for use on an aircraft for maintaining a payload such as foodstuffs and the like within a selected temperature range, said in-flight service cart including: a housing having a storage volume; and at least one thermally insulated container removably mounted within the housing, said container having an outer casing, a thermally conductive inner casing comprising a receptacle having a payload volume for storing foodstuffs within the inner casing, and thermal insulation located between the outer casing and the inner casing. The thermal insulation includes at least one vacuum insulation panel. An opening provides access to the payload volume, and a closure member is provided for closing the opening. At least one thermal energy storage unit is located within the inner casing. The thermal energy storage unit includes a phase change material that is arranged to change phase at a temperature greater than or equal to −10° C. The thermal energy storage unit(s) is positioned in thermal contact with the inner casing, the arrangement being such that the inner casing provides a thermally conductive pathway for conducting heat entering the container to the thermal energy storage unit.

The arrangement provides a means of refrigerating an in-flight service cart, in an efficient manner. The arrangement of the container enables the goods to be stored within the desired temperature range for a period of around 24 hours under typical operating conditions. Since the container includes the thermally conductive inner casing, it is possible to use a thermal heat storage unit that has an operative phase change temperature that is close to, or within, the selected temperature range. This is useful since it significantly reduces the possibility of goods freezing in the payload.

Advantageous features of preferred embodiments are disclosed in the dependent claims and the statements of invention below.

Advantageously the inner casing includes material having a thermal conductivity of at least 150 W/m·K, preferably at least 170 W/m·K, more preferably still at least 190 W/m·K, and more preferably still at least 200 W/m·K. For example, the inner casing can include at least one of aluminium and an aluminium alloy.

Advantageously the inner casing comprises a thin walled receptacle arranged to receive the payload. The inner casing includes sheet material. The inner casing includes a plurality of side walls, each made from sheet material. The sheet material can be folded to make a plurality of side walls. Additionally, or alternatively, at least one of the side walls can comprise a separate piece of sheet material, which is attached to at least one other side wall. The inner casing forms a substantially continuous shell, apart from the opening which provides access to the payload volume.

Each side wall of the inner casing is connected to a peripheral portion, such as an edge, of at least one other side wall, and preferably at least two other side walls.

In preferred embodiments the inner casing comprises a substantially cuboid receptacle, which is open at one side to provide access to the payload volume. For substantially cuboid arrangements, the inner casing includes at least five side walls. For embodiments having five side walls, one of the side walls is attached to the other four side walls, for example for an inner shell including a base, a top, and three upright sides, one of the uprights can be connected to the other four side walls at its edges. The inner casing can comprise a moulded structure as an alternative use of sheet material.

In preferred embodiments the inner casing is the inner most container layer and its inner surfaces define the payload volume. The foodstuffs (including packaging) can be placed in direct contact with the inner casing. Additionally, or alternatively, the foodstuffs may be stored on one or more trays. The inner casing can have tray supports attached thereto.

The thermal insulation is mounted on the outside of the inner casing, for example on the outer surfaces of the inner casing. The thermal insulation substantially surrounds the inner casing, apart from the opening. Thermal insulation overlies each wall of the inner casing. At least one, and preferably one, vacuum insulation panel overlies each wall of the inner casing, preferably in a manner which covers substantially the entire outer surface of the wall. In preferred embodiments at least some of the vacuum insulation panels overlap one or more adjacent insulation panels, for example at the edges of the inner casing.

The container includes mounting means for supporting the thermal energy storage unit within the inner casing. The mounting means includes at least one of a shelf, a bracket, and a ledge.

Advantageously the thermal energy storage unit includes a container for storing the PCM. In preferred embodiments the container is substantially rigid. The container is substantially cuboid. It is sized for a relatively tight fit with the inner casing and the mounting means. This ensures good thermal contact between the container and the inner casing for thermal transfer purposes. The surface area of a major surface of the thermal energy storage unit, substantially matches the surface area of at least one of the walls of the inner casing, for example at least one of a top wall and a base.

The thermal energy storage unit container includes a lifting handle. Advantageously the lifting handle is located adjacent a filling point. This provides an easy means of holding the container while filling it with PCM.

The thermal energy storage unit container includes formations for engaging the mounting means. The formations may include steps in one of the major surfaces.

The thermal energy storage unit is located within the inner casing, in an upper region thereof. Air cooled by the thermal energy storage unit tends to move towards a lower region of the inner casing.

Advantageously the thermal energy storage unit includes a phase change material that is arranged to change phase at a temperature T, wherein T is greater than or equal to one of: −9° C.; −8° C.; −7° C.; −6° C.; −5° C.; −4° C.; −3° C.; −2° C.; −1° C.; 0° C.; 1° C.; 2° C.; 3° C.; 4° C. and 5° C.

Advantageously the thermal energy storage unit includes a phase change material that is arranged to change phase at a temperature T, wherein T is less than or equal to one of: −5° C.; −4° C.; −3° C.; −2° C.; −1° C.; 0° C.; 1° C.; 2° C.; 3° C.; 4° C. and 5° C. In preferred embodiments the thermal energy storage unit includes a phase change material that is arranged to change phase at a temperature T, wherein T is within three degrees, and preferably within two degrees, of −6° C. This ensures that the phase change temperature is close to the selected temperature range.

The thermal energy storage unit includes a phase change material that mostly, or entirely, comprises of water. Alternatively the thermal energy storage unit includes a phase change material that mostly, or entirely, comprises of a hydrocarbon, such as a paraffin wax.

In some embodiments, the container includes a plurality of thermal energy storage units.

Advantageously the closure member includes an outer layer, an inner layer and thermal insulation disposed between the inner and outer layers. The thermal insulation between the inner and outer layers can include a vacuum panel.

Advantageously a seal is provided adjacent the opening, for substantially sealing the payload volume when the closure member is in a closed condition.

Advantageously the container includes a closure member locking mechanism.

The locking mechanism includes a pivotable actuator moveable between first and second positions, wherein in the first position the locking mechanism is in a locked condition and in the second position the locking mechanism is in an unlocked condition. The locking mechanism secures the closure member in its closed position, when the actuator is moved to the second position.

In preferred embodiments the actuator is mounted on the closure member.

The closure member is arranged to pivot in a plane arranged substantially parallel with the plane of the closure member. This provides a compact arrangement, which is easily accessible by the user. The actuator is pivotable about a pivot axis, wherein the pivot axis is arranged substantially parallel with a longitudinal axis of the container.

The locking mechanism includes a first locking pin, and means for moving the first locking pin in response to movement of the actuator. The first locking pin is moveable into a locking position when the actuator is moved to the second position. The first locking pin is moveable into a non-locking position when the actuator is moved to the first position.

The first locking pin is preferably mounted on the closure member. The first locking pin is movable into and out of engagement with a first locking formation. This locks and unlocks the closure member respectively. The first locking formation is preferably formed in the container body or is attached to the container body, typically to the outer casing. The means for moving the first locking pin in response to movement of the actuator includes a first lever. The first lever is pivotally attached to a first mounting formation, and pushes/pulls the first locking pin in response to movement of the actuator.

The locking mechanism includes a first resilient means for biasing the first locking pin into the locking position.

The locking mechanism includes a second locking pin, and means for moving the second locking pin in response to movement of the actuator. The second locking pin is moveable into a locking position when the actuator is moved to the second position. The second locking pin is moveable into a non-locking position when the actuator is moved to the first position.

The second locking pin is preferably mounted on the closure member. The second locking pin is movable into and out of engagement with a second locking formation. This locks and unlocks the closure member respectively. The second locking formation is preferably formed in the container body or is attached to the container body, typically to the outer casing. The means for moving the second locking pin in response to movement of the actuator includes a second lever. The second lever is pivotally attached to a second mounting formation, and pushes/pulls the second locking pin in response to movement of the actuator.

The locking mechanism includes a second resilient means for biasing the second locking pin into the locking position.

At least one of the first and second locking pins is located adjacent a first edge of the closure member. At least one of the first and second locking pins is arranged to move in a direction that is substantially parallel to an edge of the closure member. At least one of the first and second locking pins is arranged to move parallel to the first edge. Preferably at least one of the first and second locking pins is arranged to move in a direction that is substantially parallel with a vertical edge of the container, when the container is in its normal orientation.

In preferred embodiments the closure member comprises a door. The closure member is attached to the container body via a hinge. In preferred embodiments, the hinge is located towards a second edge of the closure member. The second edge is located opposite to the first edge. Preferably the closure member is hinged on a substantially vertical edge of the container, when the container is in its normal orientation.

The first and second locking pins are arranged to move along substantially the same axis.

In preferred embodiments the first and second locking pins are arranged to move in opposite directions to one another in response to movement of the actuator. This is an efficient means of providing locking near the top and bottom of the door.

In some embodiments the locking mechanism is arranged to allow the door to be pushed closed without operating the actuator. In some embodiments at least one, and preferably each, of the first and second locking pins is shaped to cause it to retract into the unlocked position when the door is pushed closed. For example, at least one, and preferably each, of the first and second locking pins includes a sloped surface. The interaction of the sloped surface with the respective locking formation pushes the locking pin into the housing against the resiliency of the resilient means. The resilient means biases the locking pin into the locked position when the door is closed.

In some embodiments at least one, and preferably each, of the first and second locking pins is shaped to pull the closure member towards the container body, thereby compressing a closure member seal. For example, at least one, and preferably each, of the first and second locking pins includes a sloped surface. The interaction of the sloped surface with the respective locking formation pulls the door towards the container body, thereby loading the closure member seal. Each sloped surface faces away from the container body. Each sloped surface is arranged such that the depth of the locking pin increases along its length, in a direction away from an end which is initially inserted into the locking formation. Thus as each locking pin is inserted into the locking formation, the load applied by the closure member and container body to the closure member seal, increases.

The actuator is pivotally attached to the closure member towards a first end.

The locking mechanism includes a guide member for guiding movement of the actuator. The guide member is located towards a second end of the actuator. In preferred embodiments, the guide member is arcuate or includes an arcuate portion.

The locking mechanism includes a handle pivotally attached to the actuator. Since the handle is pivotally attached to the actuator, it is able to rotate to a storage position, which is adjacent the outer surface of the door. This provides a compact arrangement for the container. The handle is arranged to pivot about an axis that is substantially perpendicular to the axis which the actuator pivots about. The handle is arranged to pivot about an axis that is arranged substantially parallel to a central longitudinal axis of the actuator. The handle can be used to pull the container from the in-flight service cart.

The locking mechanism includes a housing arranged to cover at least part of the actuator, the first locking pin and the second locking pin. The first and second locking pins protrude out of the housing when in the locking condition. The first and second locking pins are retracted into the housing when in the unlocked condition.

The container includes a first lifting handle. The first lifting handle is pivotally attached to the container body and typically to the outer casing. The first lifting handle is substantially U-shaped. The outer casing includes a first recess for receiving at least part of the first lifting handle. The first lifting handle at least partly sits in the first recess when in a non-deployed condition. The first lifting handle pivots about a first transverse axis, from the non-deployed condition to a fully deployed condition. The first lifting handle is mounted towards the top of the container, when the container is in its normal orientation. In preferred embodiments, when the first lifting handle is not deployed, it is arranged to lie over the closure member.

The container includes a second lifting handle. The second lifting handle is pivotally attached to the container body and typically to the outer casing. The second lifting handle is substantially U-shaped. The outer casing includes a second recess for receiving at least part of the second lifting handle. The second handle at least partly sits in the second recess when in a non-deployed condition. The second lifting handle pivots about a second transverse axis, from the non-deployed condition to a fully deployed condition. In preferred embodiments the first and second transverse axes are arranged substantially parallel to one another. The first and second axes are spaced apart from one another in a longitudinal direction of the container. The second lifting handle is mounted towards the top of the container, when the container is in its normal orientation.

The container includes a pulling handle. The pulling handle is pivotally attached to at least one of the container body, and typically to the outer casing, and the closure member. The pulling handle is substantially U-shaped. The pulling handle pivots about a pivot axis, from the non-deployed condition to a fully deployed condition. The pivot axis is arranged substantially perpendicular to at least one of the first and second transverse axes. This allows the container to be easily removed from the in-flight service cart. The pivot axis is a substantially vertical axis, when the container is in its normal operating orientation. The pulling handle is mounted towards the front of the container, adjacent the closure member. The pivot axis is arranged substantially parallel with the closure member hinge. The pulling pivot axis is arranged substantially co-axial with the closure member hinge. In preferred embodiments, the pulling handle is integrated with a closure member hinge. In the non-deployed condition, the pulling handle is positioned in a plane that his substantially parallel to the plane of the closure member.

The in-flight service cart includes a plurality of mounting rails located within the service cart housing, wherein the container includes a plurality of formations, such as recesses and/or ribs, formed in the outer casing, and the container is slidably mounted within the service cart housing by the formations engaging their respective rails. The formations are formed in side portions of the container. Typically rails are mounted to two vertical walls of the service cart. Typically the rails are arranged substantially horizontally. Typically two sides of the container each include at least one formation arranged to engage one of the rails. In preferred embodiments two sides of the container each include a plurality of formations, each recess being arranged to engage one of the rails. The recesses on a respective side of the container are vertically spaced apart.

The outer casing comprises a single piece moulding.

The container includes a plurality of vacuum insulation panels located between the outer casing and the inner casing. In preferred embodiments at least one vacuum insulation panel is provided for each container wall.

The container includes at least one drawer, which may be in the form of a removable container such as a tub or tray.

The in-flight service cart can include a plurality of removably mounted thermally insulated containers according to any configuration described herein, by adjusting the size of the housing and/or containers.

The in-flight service cart preferably includes a closure member, such as a door, for closing the service cart housing.

According to another aspect of the invention there is provided a thermally insulated container for an inflight service cart, which is arranged to be removably mounted within the inflight service cart, said container having an outer casing, a thermally conductive inner casing comprising a receptacle having a payload volume for storing foodstuffs within the inner casing, and thermal insulation located between the outer casing and the inner casing. The thermal insulation includes at least one vacuum insulation panel. An opening is provided for accessing the payload volume. The container includes a closure member for closing the opening. The container includes at least one thermal energy storage unit located within the inner casing. The thermal energy storage unit includes a phase change material that is arranged to change phase at a temperature greater than or equal to −10° C. The thermal energy storage unit(s) is positioned in thermal contact with the inner casing, the arrangement being such that the inner casing provides a thermally conductive pathway for conducting heat entering the container to the thermal energy storage unit.

The container can be arranged according to any configuration described herein.

In some embodiments the container includes a plurality of wheels. Thus the container can be arranged in the form of an in-flight service cart.

According to another aspect of the invention there is provide a thermally insulated container for transporting temperature sensitive goods, said container having a payload volume; an opening providing access to the payload volume; a closure member, such as a door, movable to a closed position to selectively close the opening; and a locking mechanism for selectively locking the closure member in the closed position. Advantageously the locking mechanism can be arranged according to any arrangement described herein.

According to another aspect of the invention there is provided a thermally insulated container for transporting temperature sensitive goods, said container having a thermally conductive inner casing; a payload volume for storing foodstuffs within the inner casing; an opening providing access to the payload volume; and a closure member, such as a door, movable to a closed position to selectively close the opening. At least one thermal energy storage unit can be located within the inner casing, said thermal energy storage unit including a phase change material (PCM). The thermal energy storage unit(s) is positioned in thermal contact with the inner casing, the arrangement being such that the inner casing provides a thermally conductive pathway for conducting heat entering the container to the thermal energy storage unit. The container can include an outer casing. The container can include thermal insulation located between the outer casing and the inner casing. The thermal insulation can include at least one vacuum panel, and preferably a plurality of vacuum panels.

According to another aspect of the invention there is provided an in-flight service cart for use on an aircraft for maintaining a payload such as foodstuffs and the like within a selected temperature range, said in-flight service cart including: a housing having a storage volume; and at least one thermally insulated container removably mounted within the housing; said container having a thermally conductive inner casing; a payload volume for storing foodstuffs within the inner casing; an opening providing access to the payload volume; and a closure member, such as a door, movable to a closed position to selectively close the opening. At least one thermal energy storage unit can be located within the inner casing. The thermal energy storage unit can include a phase change material (PCM). The thermal energy storage unit(s) is positioned in thermal contact with the inner casing, the arrangement being such that the inner casing provides a thermally conductive pathway for conducting heat entering the container to the thermal energy storage unit. The container can include an outer casing and thermal insulation located between the outer casing and the inner casing. The thermal insulation can include at least one vacuum panel, and preferably a plurality of vacuum panels.

According to another aspect of the invention there is provide a thermally insulated container for transporting temperature sensitive goods, said container having a payload volume; an opening providing access to the payload volume; and a closure member, such as a door, for selectively closing the opening. The container can include a plurality of lifting handles for lifting the thermally insulated container. The container can include at least one handle arranged for pulling the container out of an in-flight service cart. The handle is arranged, such that a user pulling on the handle slides the container out of the in-flight service cart. Typically, the container is pulled in a substantially horizontal direction when the in-flight service cart is in its normal operating orientation.

An embodiment of the invention will now be described by way of example only with reference to the accompanying drawings, in which:

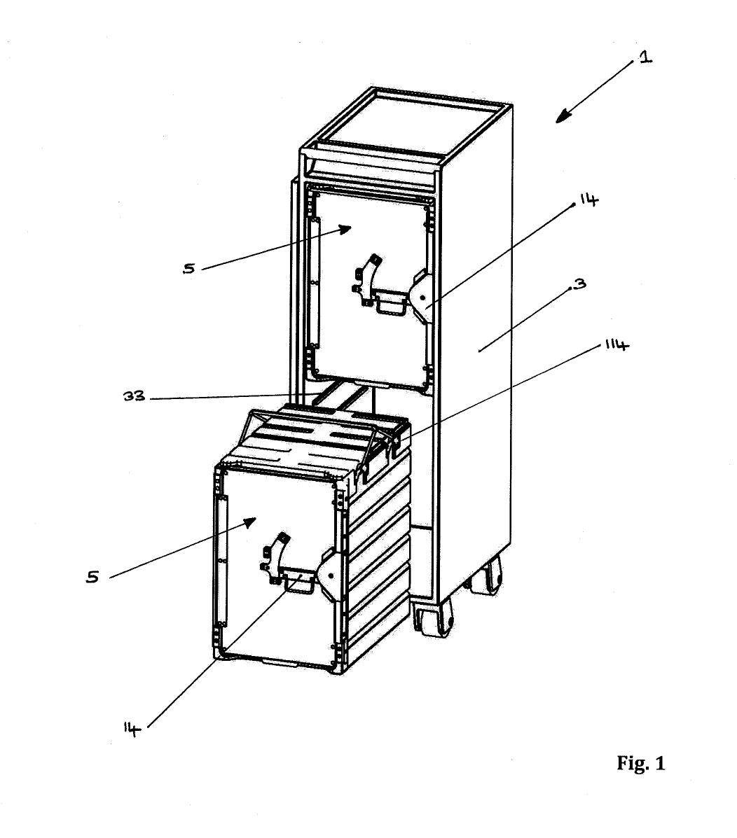

FIG. 1 is an isometric view of an in-flight service cart according to the invention;

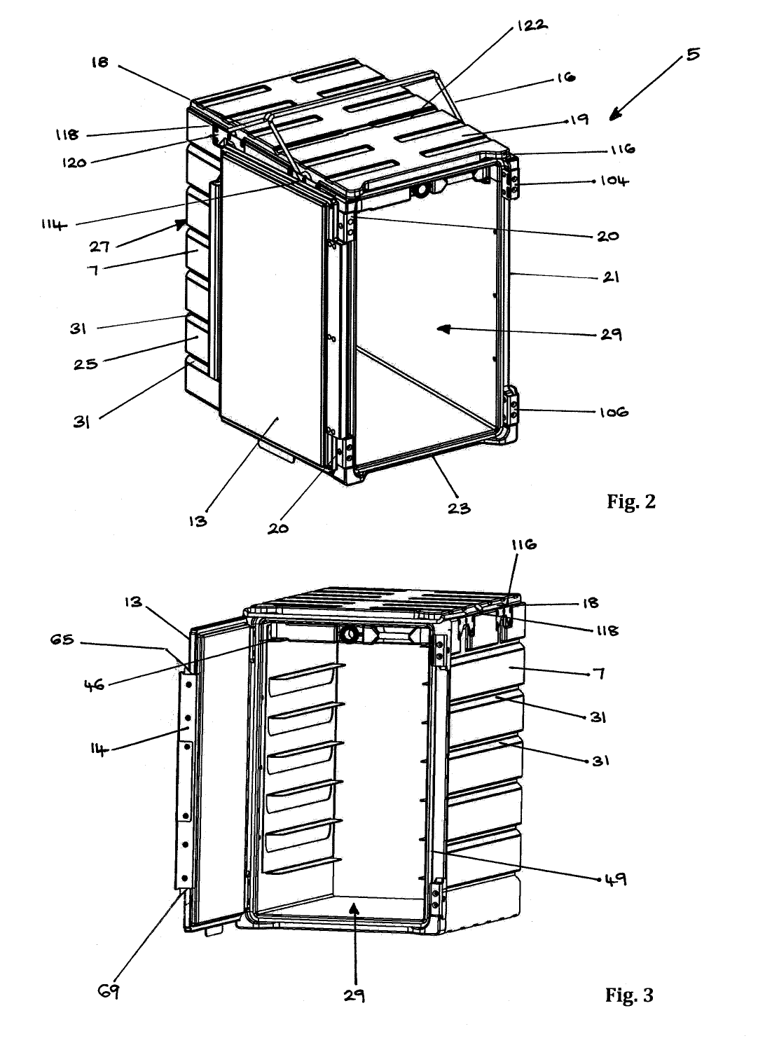

FIG. 2 is an isometric view from the front of a thermally insulated container used in the in-flight service cart of FIG. 1, with lifting handles in a lifting position, door in an open position, without inner brackets;

FIG. 3 is an isometric view of the container of FIG. 2, with lifting handles in a storage position, and including inner brackets for supporting trays;

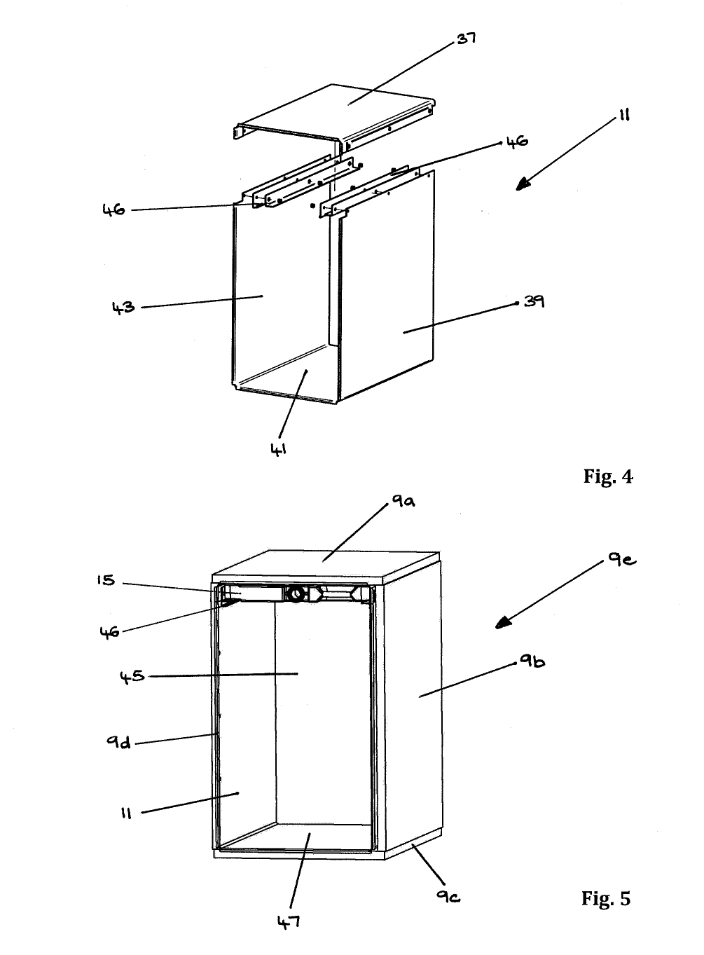

FIG. 4 is an isometric exploded view of part of a thermally conductive inner casing from the container of FIG. 2;

FIG. 5 is an isometric view of the thermally conductive inner casing from FIG. 4, clad with vacuum thermal insulation panels;

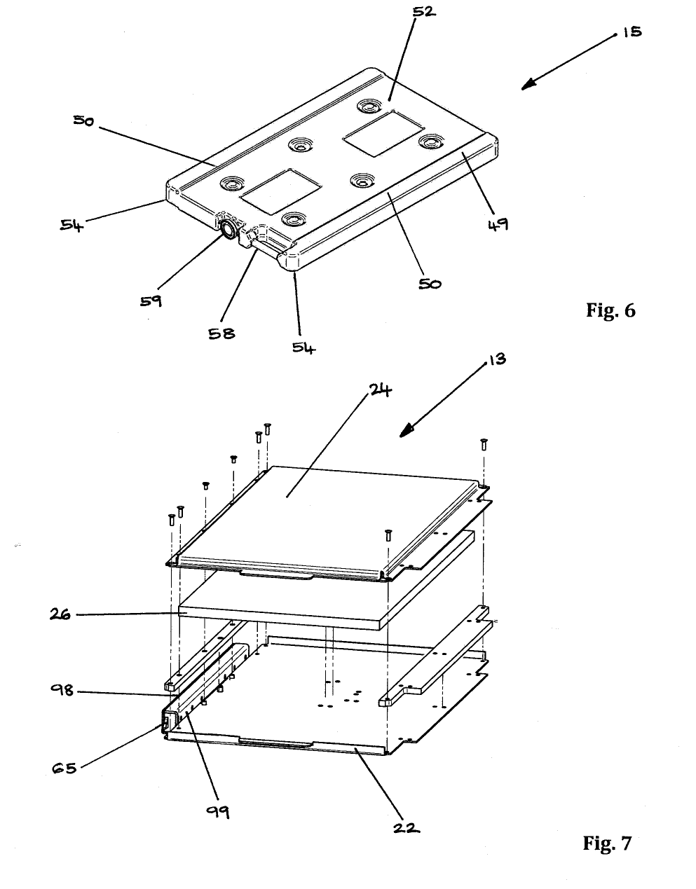

FIG. 6 is an isometric view of a PCM unit used to cool the interior of the container;

FIG. 7 is an isometric exploded view of the container door (inner side facing upwards);

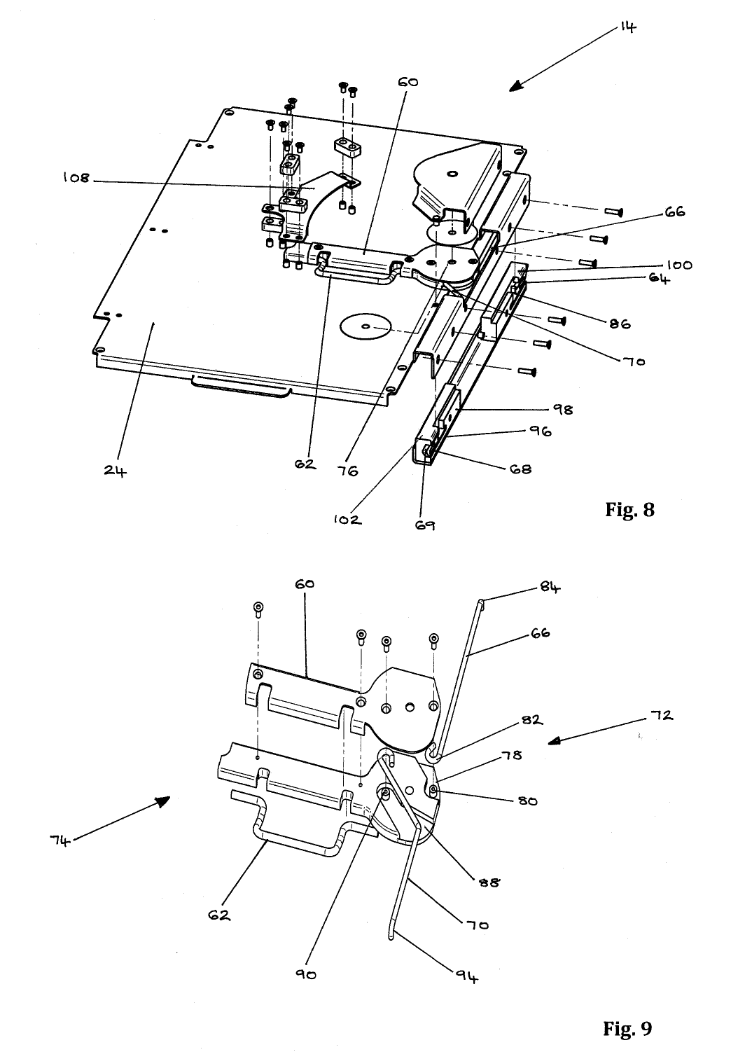

FIG. 8 is an isometric exploded view of part of the container door of FIG. 7 (outer side facing upwards), which includes a locking mechanism;

FIG. 9 is an isometric detailed view of an actuating part of the locking mechanism shown in FIG. 8;

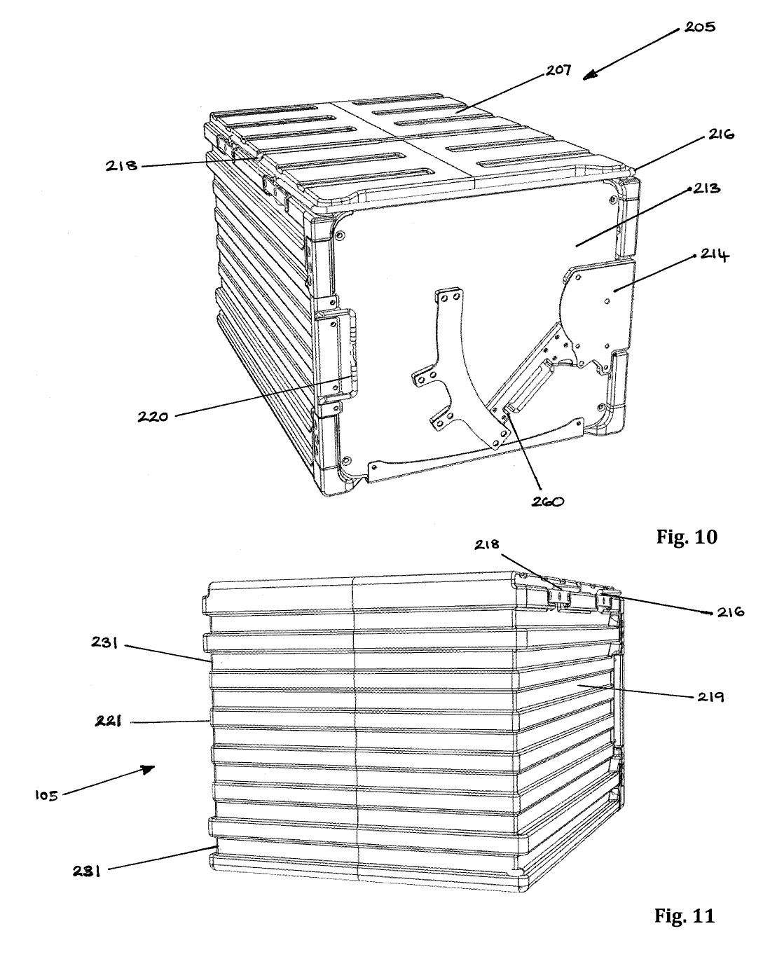

FIG. 10 is an isometric view from the front of an alternative thermally insulated container, which is arranged for use in an in-flight service cart; and

FIG. 11 is an isometric view from the rear of the container of FIG. 10.

FIG. 1 shows an in-flight service cart 1 in accordance with the present invention. The in-flight service cart 1 includes a housing 3 that is arranged to accommodate at least one, and typically two, thermally insulated containers 5, which are removably mounted within the service cart 1. Each container 5 provides a payload volume for storing foodstuffs, such as food and beverages, and is arranged to maintain the foodstuffs within a temperature range of +2° C. to +8° C.

Each container 5 includes an outer casing 7, thermal insulation 9, which includes five vacuum panels 9a-e, an inner casing 11, a door 13, and a thermal energy storage unit 15. Each container 5 further includes a door locking mechanism 14, a first lifting handle 16 and a second lifting handle 18.

The outer casing 7 provides mechanical strength and impact resistance. The outer casing 7 is substantially rigid. The outer casing 7 is made from a plastics material, such as high density polyethylene (HDPE). The outer casing 7 is a moulded component, for example made by a rotary moulding process, so that there are no seams. The outer casing 7 is substantially cuboid and includes side walls 19,21,23,25,27. The outer casing 7 is open at one side 29.

Recesses 31 are formed in an outer surface of at least some of the outer casing side walls 19,21. The recesses 31 are arranged to engage rails 33 formed in the interior of the in-flight service cart 1. The arrangement is such that the container 5 can be mounted on the rails 33 and can be manually moved into and out of the housing 3 by sliding the container 5 along the rails 33.

The inner casing 11 is located within the outer casing 7. The inner casing 11 includes side walls 37,39,41,43,45 (see FIG. 4). The inner casing 11 is open at one side 47. The inner casing 11 is substantially cuboid, save for the open side.

The inner casing 11 is made from a material having good thermal conductivity properties and is arranged to conduct heat entering the container 5 to the thermal energy storage unit 15. Thus the inner casing 11 effectively conducts heat around the foodstuffs in the payload volume. Typically the inner casing 11 is made from a material having a thermal conductivity of at least 150 W/m·K such as aluminium or copper, though aluminium is preferred due to its lower density, since this leads to a lower weight container 5. Weight is very important in aircraft applications. Aluminium is also preferred because it provides a food safe surface.

The vacuum insulation panels 9a-e are located between the outer casing walls 19,21,23,25,27 and the inner casing walls 37,39,41,43,49. Each vacuum insulation panel 9a-e includes a fumed silica core (not shown) and is evacuated to provide good insulating properties. Each vacuum insulation panel 9a-e is mounted on, or to, one of the inner casing walls 37,39,41,43,49, and is sized and shaped to substantially cover its respective wall. The panels 9a-e are arranged to overlap adjacent panels at their edges in the manner shown in FIG. 5. This helps to ensure that each wall of the inner casing is properly insulated.

The thermal energy storage unit 15 is supported within the inner casing 11 by at least one support formation such as a bracket 46, ledge, or shelf. The thermal energy storage unit 15 is located in an upper region of the inner casing, preferably adjacent to the upper wall 37.

For arrangements including the shelf, the shelf splits the interior of the inner casing 11 into a first volume arranged to accommodate the payload and a second volume that is arranged to store the thermal energy storage unit 15.

The thermal energy storage unit 15 includes a substantially rigid container 49. The container is moulded and is preferably made from a plastics material such as HDPE, for example by a roto-moulding process. The container is filled with a phase change material. In preferred arrangements the phase change material is arranged to change phase at a temperature that is greater than or equal to −10° C., and preferably around −6° C. It has been found that using PCMs that change phase at temperatures in the range −8° C. to −3° C. provide a good balance for providing long-term cooling (up to 24 hours), while reducing the risk of food freezing. In is preferred to use a PCM that melts/freezes at that phase change temperature. Typically the PCM is a salt solution. PCMs that change phase at temperatures, such as −9° C.; −8° C.; −7° C.; −5° C.; −4° C.; −3° C.; −2° C.; −1° C.; 0° C.; 1° C.; 2° C.; 3° C.; 4° C.; and 5° C. can also be used.

The phase change material is selected so that the phase change (melting/freezing in this case) temperature is significantly closer to the operating range of the payload volume than prior art devices that use dry ice. The advantage of this is that the risk of any of the foodstuffs freezing during operation is significantly reduced, while providing effective cooling to the foodstuffs to ensure that they stay within the desired temperature range. Being able to select a phase change material that changes phase at a temperature that is greater than or equal to −10° C. is achievable because of the use of the thermally conductive inner casing 11, which conducts heat entering the container to the thermal energy storage unit 15, thereby dissipating the heat.

The thermal energy storage unit container 49 includes longitudinal raised formations 50 in the form of longitudinal ribs on at least one of its major surfaces 52. The raised formations 50 provides a small spacing which allows for expansion of the container 49. The container 49 includes longitudinal recesses 54 in the other major surface 56. The recesses 54 engage the brackets 46.

The thermal energy storage unit container 49 includes a handle 58 located adjacent a filling port 59.

The typical capacity of the thermal energy storage unit container 49 is around 1 litre for a thermally insulated container 5 having a payload volume of around 0.018 m³.

In use, the thermal storage energy unit 15 is pre-conditioned in a freezer to reduce its temperature to around −20° C. The thermal energy storage unit so conditioned will maintain the temperature in the payload within the range +2° C. to +8° C. for around 24 hours in an aircraft having an average ambient temperature of around 20° C. (typically between 10° C. and 30° C.), with a significantly low risk of any of the foodstuffs freezing.

The door 13 is arranged to provide access to the payload volume. The door 13 is attached to the side wall 25 of the outer casing via hinges 20. The door 13 includes an outer layer 22, an inner layer 24 and thermal insulation 26 located between the inner and outer layers 22,24. Optionally, the thermal insulation 26 may include a vacuum insulation panel. Preferably the inner and/or outer layer 22,24 of the door is made from a plastics material such as ABS. Other materials, such as sheet metal can be used.

A seal 49 is provided to seal the door 13 to the walls of the container 5. The seal 49 reduces the ingress of heat and contaminants into the container.

The locking mechanism 14 is located on an outer surface of the door 13. The locking mechanism includes a manually operable actuator 60, a handle 62, a first locking pin 64, a first rod 66, a second locking pin 68 and a second rod 70.

The handle 62 is pivotally attached to the actuator 60. The user uses the handle 62 to move the actuator 60 from a locking position to a non-locking position, and vice versa. The handle 62 can be used to pull the container 5 from the in-flight service cart 1.

The actuator 60 includes first and second ends 72,74. The actuator 60 is pivotally attached, towards its first end 72, to the door 13 by a pivot pin 76. The actuator 60 is arranged to rotate through an angle of around 40 degrees between the locking and non-locking positions.

The first end 72 of the actuator includes a first recess 78 having a first mounting 80. A first end 82 of the first rod is pivotally attached to the actuator 60 via the first mounting 80. A second end 84 of the first rod engages the first locking pin 64. The first rod 66 is arranged to move the first locking pin 64 between locking and non-locking positions in response to movement of the actuator 60. A first spring 86 biases the first locking pin 64 towards the locking position. The first locking pin 64 includes an inclined engagement surface 65.

The first end 72 of the actuator includes a second recess 88 having a second mounting 90. A first end 92 of the second rod is pivotally attached to the actuator 60 via the second mounting 90. A second end 94 of the first rod engages the second locking pin 68. The second rod 70 is arranged to move the second locking pin 68 between locking and non-locking positions in response to movement of the actuator 60. A second spring 96 biases the second locking pin 68 towards the locking position. The second locking pin 68 includes an inclined engagement surface 69.

The first and second locking pins 64,68 are mounted in an elongate housing 98. The first locking pin 64 is located towards a first end 100 of the housing. The first locking pin 64 is arranged to move along a first axis from a first (non-locking) position where it is fully stowed with the housing 98 to a second (locking) position where it protrudes from the housing, and vice versa, in response to movement of the actuator 60. The second locking pin 66 is located towards a second end 102 of the housing. The second locking pin 68 is arranged to move along the first axis from a first (non-locking) position where it is fully stowed with the housing 98 to a second (locking) position where it protrudes from the housing, and vice versa, in response to movement of the actuator 60.

The housing 98 is mounted on door 13 towards one edge 99 thereof, typically the edge opposite to the one having the hinges 20. The housing 98 is oriented so that it is substantially parallel to the edge 99 of the door 13. Thus, the first and second locking pins 64,68 move along an axis that is substantially parallel with the edge 99 of the door. In this instance the axis is a substantially vertical axis. Lock formations 104,106 are mounted on the side wall 21 of the outer casing adjacent the first and second ends 100,102 of the housing, when the door 13 is in the closed condition. The first and second lock formations 104,106 are arranged to receive the first and second locking pins 64,68 respectively when they protrude from the housing 98 in the locking positions. The lock formations 104,106 hold the door 13 in the closed position when the locking mechanism 14 is actuated by a user.

Since the locking pins 64,68 include inclined surfaces 65,69 and springs 86,96, it is possible for the user to push the door closed in a manner that automatically locks the door, without having to manually operate the actuator 72. When the door is pushed towards the closed position, the inclined surfaces 65,69 engage their respective lock formations 104,106. This causes the locking pins 64,68 to at least partially retract into the housing 98, thereby loading the springs 86,96. The locking pins 64,68 reach a position where they are no longer blocked by the locking formations 104,106 and the door moves to the fully closed position. The loaded springs 86,96 move the locking pins 64,68 into their locking positions when the door is fully closed.

An arcuate-shaped guide 108 is mounted on the door 13 towards the second end 74 of the actuator. The guide 108 guides movement of the actuator 60, and ensures that the force applied does not twist the actuator 60 out of its normal rotational plane.

The first lifting handle 16 is substantially U-shaped and is pivotally attached to an upper part of the container, via pivot pins 114. The first lifting handle is arranged to lie in a first recess 116,118 formed in the outer casing 7. The first lifting handle 16 can be arranged to lie over an upper part of the door 13 when stowed in the first recess 116,118. The second lifting handle 18 is substantially U-shaped and is pivotally attached to an upper part of the container, via pivot pins 120. The second lifting handle 18 is arranged to lie in a second recess 118,122, formed in the outer casing 7. The first and second lifting handles extend transversely across the container. Each handle 16,18 arranged to pivot about a respective axis that is arranged substantially perpendicularly to the longitudinal axis of the container, and to the axis about which the door pivots.

It will be appreciated by the skilled person that various modifications of the above embodiment are possible that fall within the scope of the current invention, such as different types of PCM may be used. For example, a hydrocarbon type PCM, such as a paraffin wax, can be used instead of a salt solution.

The thermal conductivity of the inner casing material can be at least 100, 120, 140, 160, 180, 200 W/m·K. The inner casing can be made from any suitable material, preferably a metal, and can be made from an alloy such as an aluminium alloy.

If necessary, additional thermal energy storage units 15 can be provided.

Wheels can be fitted to one of the containers 5 described in the embodiment above so that the container 5 itself becomes an in-flight service cart. In this case, it would be desirable to increase the size of the container so that it is similar in size to an existing in-flight service cart.

The door can include an inner casing material similar to the container walls.

The door can be replaced by a removable lid.

At least one of the containers mounted in the in-flight service cart can be arranged in accordance with the container 105 shown in FIGS. 10 and 11. The container 205 is similar to the container 5. For example, the container 205 includes an outer casing 207, thermal insulation, which includes five vacuum panels, an inner casing, a door 213, and at least one thermal energy storage unit. The container 105 further includes a door locking mechanism 214, a first lifting handle 216 and a second lifting handle 218.

The container 205 differs from the container 5 in the following respects.

The container 205 includes a handle 220 at the front of the container. The handle 220 is provided such that a user is able to pull the container 205 from the in-flight service cart. The handle 220 pivotally attached to the container 205. The handle 220 can be pivoted to a stowed position wherein it lies in a plane that is substantially parallel to the plane of the container door 213. The handle 220 can be pivoted to a pulling position where it is arranged substantially parallel to the plane of the door 213. The handle 220 is attached towards one edge of the container, typically the edge 220 to which the door is hinged. At least part of the handle is arranged substantially co-axially with the door hinge, and preferably the handle 220 is integrated into the door hinge. That is, extended parts of the handle 220 pivotally attach the door 213 to the container body.

Having an additional pulling handle 220 reduces loading on the locking mechanism 214 when removing the container 205 from the in-flight service cart.

The locking mechanism 214 has some differences compared with the locking mechanism 14. The locking mechanism 14 in the first embodiment is arranged to enable the door to be pushed closed, in that the locking pins 64,68 include inclined surfaces 65,69 which face towards the container body and the mechanism includes springs 86,96, which allow the locking pins 64,68 to retract into the housing 98 and biases the locking pins 64,68 into locking engagement with the locking formations 104,106.

In the contrast, the locking mechanism 214 cannot be pushed closed. It requires operation of the manually operably actuator 260 to close the door. The mechanism 214 does not include springs. Furthermore, the inclined surfaces on the locking pins face outwards, that is away from the container body and locking formations (i.e. opposite to the inclined surface 69 in FIG. 8). The advantage of having inclined faces on the rear of the locking pins is that the interaction of the inclined faces and locking formations pulls the door towards the container body, as the locking pins are inserted into their respective locking formations, thereby compressing the door seal. This increases the closing pressure on the door, which helps to ensure a good seal is achieved.

Optionally the door 213 can having an inner layer, which is thermally conductive. For example, the door can have an inner layer which is made from the same material as the inner casing.

The outer dimensions of the container 205 can be different from the container 5, and the recesses 231 formed in the outer casing side walls 219,221 have a different configuration. This enables the container to be mounted in a different in-flight service cart.

1. An in-flight service cart for use on an aircraft for maintaining a payload within a selected temperature range, said in-flight service cart including: a housing having a storage volume; and at least one thermally insulated container removably mounted within the housing, said container having an outer casing, a thermally conductive inner casing comprising a receptacle having a payload volume for storing foodstuffs within the inner casing, thermal insulation located between the outer casing and the inner casing, said thermal insulation including at least one vacuum insulation panel, an opening providing access to the payload volume, a closure member for closing the opening, at least one thermal energy storage unit located within the inner casing, said thermal energy storage unit including a phase change material that is arranged to change phase at a temperature greater than or equal to −10 □ C.; wherein the thermal energy storage unit(s) is positioned in thermal contact with the inner casing, the arrangement being such that the inner casing provides a thermally conductive pathway for conducting heat entering the container to the thermal energy storage unit.

2. The in-flight service cart according to claim 1, wherein the inner casing includes material having a thermal conductivity of at least 150 W/m·K, preferably at least 170 W/m·K, more preferably still at least 190 W/m·K, and more preferably still at least 200 W/m·K.

3. The in-flight service cart according to claim 1, wherein the inner casing includes at least one of aluminium and an aluminium alloy.

4. The in-flight service cart according to claim 1, wherein the inner casing comprises a substantially cuboid structure.

5. (canceled)

6. The in-flight service cart according to claim 1, wherein the inner casing receptacle comprises a thin walled structure.

7. The in-flight service cart according to claim 1, wherein the thermal insulation is mounted on the outside of the inner casing, and overlies each wall of the inner casing.

8. The in-flight service cart according to claim 1, including a plurality of vacuum insulation panels located between the outer casing and the inner casing.

9. The in-flight service cart according to claim 1, including at least one of a shelf, a bracket, and a ledge for supporting the thermal energy storage unit in an upper region of the casing.

10. (canceled)

11. The in-flight service cart according to claim 1, wherein the phase change material that is arranged to change phase at a temperature which is: greater than or equal to −9° C. and/or less than or equal to 5° C.

12. (canceled)

13. (canceled)

14. The in-flight service cart according to claim 1, wherein the thermal energy storage unit includes a phase change material that mostly, or entirely, comprises salt solution; or that mostly, or entirely, comprises of a hydrocarbon.

15. (canceled)

16. The in-flight service cart according to claim 1, wherein the thermal energy storage unit includes a substantially rigid container.

17. (canceled)

18. The in-flight service cart according to claim 1, wherein the closure member includes an outer layer, an inner layer and thermal insulation disposed between the inner and outer layers, wherein the thermal insulation between the inner and outer layers includes a vacuum panel.

19. (canceled)

20. (canceled)

21. The in-flight service cart according to claim 1, wherein the closure member comprises a door.

22. The in-flight service cart according to claim 1, including a closure member locking mechanism.

23. The in-flight service cart according to claim 22, wherein the locking mechanism includes a pivotable actuator moveable between first and second positions, wherein in the first position the locking mechanism is in a locked condition and in the second position the locking mechanism is in an unlocked condition, and wherein the actuator is mounted on the closure member.

24. (canceled)

25. The in-flight service cart according to claim 23, wherein the actuator is arranged to pivot in a plane arranged substantially parallel with the plane of the closure member, and the actuator is pivotable about a pivot axis, wherein the pivot axis is arranged substantially parallel with a longitudinal axis of the container.

26. (canceled)

27. The in-flight service cart according to claim 23, wherein the locking mechanism includes a first locking pin, means for moving the first locking pin in response to movement of the actuator, a first resilient means for biasing the first locking pin into a locking position, a second locking pin, means for moving the second locking pin in response to movement of the actuator, and a second resilient means for biasing the second locking pin into a locking position.

28. (canceled)

29. (canceled)

30. (canceled)

31. (canceled)

32. The in-flight service cart according to claim 29, wherein the first and second locking pins are arranged to move along substantially the same axis and are arranged to move in opposite directions to one another in response to movement of the actuator.

33. (canceled)

34. (canceled)

35. The in-flight service cart according to claim 27, wherein at least one of first and second locking pins is arranged to move from a locking position to an unlocked position when the closure member is pushed closed, thereby enabling a user to push the door to the closed position.

36. The in-flight service cart according to claim 27, wherein at least one of the first and second locking pins includes a sloped engagement surface arranged to engage its respective locking formation, and wherein contact between the sloped engagement surface and its respective locking formation, moves the locking pin from the locked position to the unlocked position and pulls the closure member towards the container body.

37. (canceled)

38. (canceled)

39. The in-flight service cart according to claim 23, wherein the actuator includes first and second ends, and is pivotally attached to the closure member towards the first end, and further including a guide member for guiding movement of the actuator.

40. (canceled)

41. The in-flight service cart according to claim 23, including a handle pivotally attached to the actuator.

42. (canceled)

43. (canceled)

44. (canceled)

45. (canceled)

46. The in-flight service cart according to claim 1, including a handle for pulling the container out of the in-flight service cart, wherein the handle for pulling the container out of the inflight service cart is integrated with a closure member hinge.

47. (canceled)

48. The in-flight service cart according to claim 1, including a plurality of mounting rails located within the service cart housing, wherein the thermally insulated container includes a plurality of recesses formed in the outer casing, and the container is slidably mounted within the service cart housing by the rails engaging respective recesses.

49. The in-flight service cart according to claim 1, wherein the outer casing comprises a single piece moulding.

50. (canceled)

51. (canceled)

52. The in-flight service cart according to claim 1, including a closure member for closing the service cart housing.

53. A thermally insulated container for an inflight service cart, which is arranged to be removably mounted within the inflight service cart, said container having an outer casing, a thermally conductive inner casing comprising a receptacle having a payload volume for storing foodstuffs within the inner casing, thermal insulation located between the outer casing and the inner casing, said thermal insulation including at least one vacuum insulation panel, an opening providing access to the payload volume, a closure member for closing the opening, at least one thermal energy storage unit located within the inner casing, said thermal energy storage unit including a phase change material that is arranged to change phase at a temperature greater than or equal to −10° C.; wherein the thermal energy storage unit(s) is positioned in thermal contact with the inner casing, the arrangement being such that the inner casing provides a thermally conductive pathway for conducting heat entering the container to the thermal energy storage unit.

54. (canceled)

55. (canceled)

56. An in-flight service cart for use on an aircraft for maintaining a payload within a selected temperature range, said in-flight service cart including: a housing having a storage volume; and at least one thermally insulated container removably mounted within the housing, said thermally insulated container having: an outer casing; a thermally conductive inner casing comprising a substantially cuboid receptacle having a payload volume for storing foodstuffs within the inner casing, said inner casing including material having a thermal conductivity of at least 100 W/m·K; thermal insulation located between the outer casing and the inner casing, said thermal insulation including at least one vacuum insulation panel; an opening at one side providing access to the payload volume; a door for closing the opening, said door is hinged at a substantially vertical edge of the thermally insulated container when the container is in its normal operating orientation; and at least one thermal energy storage unit located within the inner casing, said thermal energy storage unit including a phase change material that is arranged to change phase at a temperature greater than or equal to −10° C., wherein the thermal energy storage unit(s) is positioned in thermal contact with the inner casing, the arrangement being such that the inner casing provides a thermally conductive pathway for conducting heat entering the container to the thermal energy storage unit.
